(19) United States
(12) Patent Application Publication
(10) Pub. No.: US 2008/0154827 A1
(43) Pub. Date: Jun. 26, 2008

(54) METHOD OF COMPARING ACTUAL AND USER PREDICTED CHANGES IN DATA

(76) Inventor: Laurence A. Connors, Woodland Hills, CA (US)

Correspondence Address: STETINA BRUNDA GARRED & BRUCKER, 75 ENTERPRISE, SUITE 250, ALISO VIEJO, CA, 92656, US

(21) Appl. No.: 11/613,980

(22) Filed: Dec. 20, 2006

(51) Int. Cl. G06N 5/02

(52) U.S. Cl. 706/46

(57) ABSTRACT

A method of comparing actual and user predicted changes in data over a time period is provided. Each time period comprises a plurality of sequential time intervals. Historical data containing historical data values is received from a data input. The change in historical data value between a given time interval and a subsequent time interval is an authentic change. The historical data for each time interval is displayed on a user interface. A data prediction is received for each time interval from a prediction input. The data prediction is whether the historical data value of the subsequent time interval will increase or decrease as compared to the historical data value of the current time interval. The data prediction for each time interval is then compared with the authentic change. The number of data predictions matching the authentic changes over the time period is the user score.

### CROSS-REFERENCE TO RELATED APPLICATIONS

Not Applicable.

### STATEMENT RE: FEDERALLY SPONSORED RESEARCH/DEVELOPMENT

Not Applicable

### BACKGROUND

This invention relates in general to predicting changes in data over a given length of time, and more particularly to a method of comparing actual and user predicted changes in data over a time period have a plurality of sequential time intervals.

Over the years, many people have attained financial success by trading various types of financial instruments, such as securities, stocks, bonds, currencies, options, futures and derivatives thereof. Traders are able to profit off of financial instruments by purchasing a financial instrument, waiting for its value to increase, and then selling it. As such, when financial markets fluctuate, traders stand to gain financially.

There is a wide range of philosophies used when trading financial instruments. Some people employ a conservative approach and hold on to their financial instruments for long periods of time. In the meantime, market values continuously fluctuate during a given timeframe or trading session. As such, others employ a different philosophy in an effort to take advantage of the fluctuations in the financial markets. Such traders will be referred to herein as day-traders.

Day-trading can be a very stimulating and rewarding activity that may enable a trader to accrue large amounts of money in a very short period of time. Current advancements in technology have allowed the day-trading field to blossom. The Internet allows a day-trader to monitor a market and execute trades anywhere in the world. A day-trader may execute dozens of trades throughout the course of a typical day. Trades accumulated during the day can result in large amounts of money, even though individual trades may be small.

Although the potential for success in day-trading is evident, many people find day trading intimidating. A number of people are intimidated by the risk and possible expense involved in day-trading. Others are concerned with the inconvenience of establishing an account with a brokerage house and dealing with trade commissions. Still others maintain that the shear volume of trading done by the typical day trader is intimidating.

One of the first steps in becoming a successful day-trader is mitigating fear that may be associated with day-trading. The first step in mitigating that fear is to become educated and experienced in day-trading. Many day-traders fail almost immediately because they jump into a market without having sufficient prior knowledge of how the market shifts. A beginner who simply starts trading runs a high risk of losing large amounts of money. The main goal in any day-trading training process is to begin to develop a trading plan or system. This requires a high level of discipline on the part of the day-trader. Over time, the trader develops an instinct as to how a particular market behaves and moves.

There are many courses and programs that are offered to beginning day-traders. Although these courses and programs are often suitable means of obtaining a sufficient background in the area of day-trading, they do not provide a novice trader with the necessary experience to begin day-trading.

One of the most effective methods of gaining experience as a day-trader is practicing using real time or near real time market data. Most successful day-traders are able to analyze previous market data in order to forecast future trends in the market. A day-trader does not have to know or predict the peaks and valleys in financial market data. Rather, they are merely required to know what direction the market is moving. For instance, if they know the market is going to move up, the trader will buy. On the other hand, if they believe the market is moving down, the trader will sell existing positions or open new short positions. Therefore, a novice trader can gauge how efficiently he is predicting trends in the market by comparing his forecasted trend with the actual trend.

It is therefore evident that there exists a need in the art for a method enabling a user to compare changes in data with user predicted changes in data.

### BRIEF SUMMARY

According to an aspect of the present invention, there is provided a method of comparing actual and user predicted changes in data over a time period. Each time period is comprised of a plurality of sequential time intervals. The method includes receiving historical data from a data input. The historical data includes historical data values with authentic changes. Each authentic change is a change in historical data value between a current time interval and a subsequent time interval. The historical data for each time interval is displayed on a user interface. A data prediction is received for each time interval from a prediction input. The data prediction is whether the historical data value of the subsequent time interval will increase or decrease as compared to the historical data value of the current time interval. The data prediction for each time interval is then compared with the authentic change. A user score is then generated. As used herein, the user score is the number of data predictions matching the authentic changes over the time period.

The above described method enables a user to analyze data to make a prediction and then compare such prediction with the actual change in data. It is contemplated that an embodiment of the present invention may include a day-trading training tool to enable a novice day-trader to compare a predicted change in the market with the actual change in the market.

The method may include the step of storing the historical data in a historical database. In addition, the data prediction may be received from a user input and stored in a user input database. Furthermore, the historical data received may relate to different types of data such as financial data.

The historical data may also interface with real-time data. As such, the data input would be a live-data feed. In another embodiment, the historical data may contain previously recorded data. For instance, the historical data may contain recorded stock prices from a previous time period, such as a previous hour, day, week, month, year, etc.

The length of each time interval and time period may vary. For example, it may be beneficial to have each time interval equal. It is understood that although each time interval may be equal to five minutes for example, the user may be prompted to enter a data prediction at a faster rate. For instance, if the historical data contains previously recorded data, the user would not have to wait five minutes to make the next data prediction. Rather, the user may be provided with the historical data for a subsequent time interval immediately after making the data prediction for a previous time interval.

It is understood that the data prediction is received from a prediction input. In one embodiment, the prediction input may be the user himself. In that case, the data prediction is received from the user. In another embodiment the prediction input may be a default source. The default source is capable of sending the data prediction if the user does not enter the data prediction. According to various embodiments, the default source may be programmed to enter a data prediction of either “increase” or “decrease.”

According to another aspect of the present invention, there is provided a method of comparing actual and user predicted changes in data over a time period for multiple users. Historical data is received and displayed on a user interface. It is understood that a user interface may be provided for each user. A data prediction for each user is received for each time interval. Each data prediction received is then compared with the authentic change in historical data value. A user score is generated for each user, and then a winning score may be identified. The winning score is the user having the highest user score.

According to an embodiment of the present invention, software may be provided which facilitates the execution of the aforementioned method steps. Such software may be useful as a training tool for traders of financial instruments, particularly day traders or short-term traders. In this regard, the software may provide a mechanism for a user to practice predicting short-term increases and decreases in the financial markets.

It is contemplated that the present invention may also be advantageously used in video game and gaming applications. The player may compete against himself, to achieve a personal high score, or multiple players may compete against each other to achieve the winning score. Prizes may be awarded to the user attaining the winning score.

According to another aspect of the present invention, there is provided an article of manufacture comprising a program storage medium readable by a computer. The medium tangibly embodies one or more programs of instructions executable by a computer to perform a method of comparing actual and user predicted changes in data over a time period having a plurality of sequential time intervals. The method comprising the steps of receiving and displaying historical data from a data input. The method further includes the step of receiving a data prediction for each time interval. The data prediction is then compared to the authentic change. Finally, a user score is generated.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a symbolic diagram illustrating a system for implementing the method of comparing actual changes and user predicted changes in data; and

FIG. 2 is a symbolic diagram illustrating a system for implementing the method of comparing actual changes and user predicted changes in data, the system being capable of accommodating multiple users.

### DETAILED DESCRIPTION

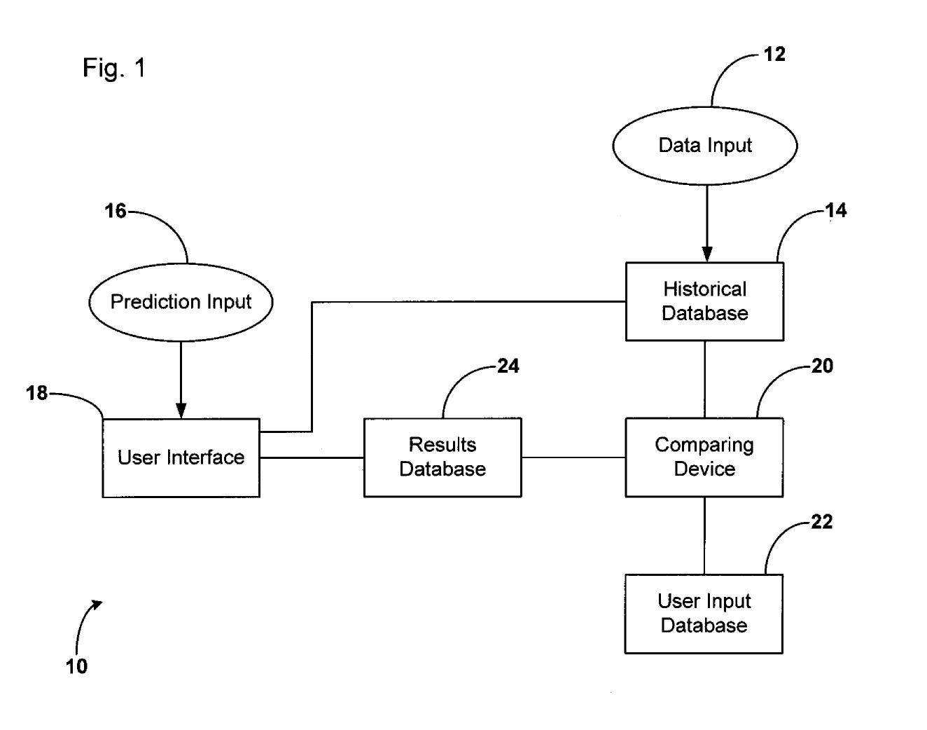

Referring now to the drawings wherein the showings are for purposes of illustrating a preferred embodiment of the present invention only, and not for purposes of limiting the same, FIG. 1 illustrates a system 10 for implementing a method of comparing actual and user predicted changes in data over a time period. It is understood that each time period is comprised of a plurality of sequential time intervals.

The present invention relates to comparing user predicted changes in data with authentic changes in data. According to an embodiment of the present invention, the method includes receiving historical data from a data input 12. As used herein, historical data may relate to any type of measurable data. In other words, historical data may be interpreted to include any and all data having a quantifiable value. For instance, historical data may relate to financial market data, such as stock prices, currency rates, and commodity prices. The quantifiable values of the historical data are referred to as historical data values. The historical data includes a historical data value for each time interval. The historical data value of a subsequent time interval is likely to differ from the historical data value of the proceeding time interval. The change in historical data value between a given time interval and a subsequent time interval will be referred to herein as the authentic change.

As was mentioned above, the historical data is received from a data input 12. The data input 12 may include a live data feed, or it may be a database which supplies the historical data. For example, if the historical data relates to stock prices, in the case of a live data feed, the data input 12 may supply real-time data concerning a particular stock. In the case of a database, the data input 12 may supply pre-recorded data concerning the particular stock.

After receipt of the historical data, it is displayed on a user interface 18. According to various embodiments, the user interface 18 may be a computer monitor, television, portable media device, gaming device, cell phone, or other display devices known by those skilled in the art. The data may be plotted on a graph or chart with historical data value plotted against some time increment, such as a bar graph, or a typical stock chart. The user analyzes the historical data displayed on the user interface 18 until the user is prompted to enter a data prediction. The data prediction is whether the historical data value of the subsequent time interval will increase or decrease as compared to the historical data value of the current time interval. If the user believes the historical data value of the subsequent time interval will be greater than the historical data value of the given time interval, the data prediction will be “increase” or “up.” Alternatively, if the user believes the historical data value of the subsequent time interval will be less than the historical data value of the given time interval, the data prediction will be “decrease” or “down.”

The data prediction is received from a prediction input 16 and may be stored in a user input database 22. The prediction input 16 may vary according to alternate embodiments. In one embodiment, the prediction input 16 may be the user himself. As described above, the user will analyze the historical data in formulating a prediction and enter a prediction input 16. However, if the user is prompted to enter a prediction and no prediction is entered by the user, a default source may enter the data prediction 16. In this case, the default source is the prediction input 16. The default source may be programmed to enter a default data prediction of increase or decrease. Therefore, in such an embodiment, the method may continue even if a data prediction is not entered by the user.

After the data prediction for a given time interval is received, the user interface 18 displays the historical data for the subsequent time interval. As such, the user interface is constantly updated with new historical data. The data prediction for each time interval is compared with the authentic change for each time interval. In other words, the predicted change in historical data value is compared with the actual change in historical data value. The comparing is done by a comparing device 20. The comparing device 20 may be any device known by those skilled in the art capable of performing such comparison. After comparing the data prediction with the authentic change, a user score is generated. The user score is the number of data predictions matching the authentic changes over the time period. After generating the user score, it may be stored in a results database 24.

It is contemplated that the above-described method may be particularly useful as a training tool for those who trade financial instruments, specifically day-traders. Day-traders invest in financial instruments, such as stocks, bonds and currencies with the hopes of profiting off of short-term fluctuations in the financial markets. As such, day-traders must successfully predict short-term changes in market data. A training tool using the method described above would allow a trader to develop the necessary skill to become a successful day trader by comparing his prediction with the actual change in market data.

As was mentioned above, the historical data may relate to many different types of data. However, in the case of a day-trading training tool, the historical data may relate to financial market data, including, but not limited to stock prices for the stock market, currency rates for the currency market, and commodity prices for the commodities market.

According to various embodiments of the present invention, the historical data may be real-time, pre-recorded, or randomized data. In the training tool embodiment, it may be beneficial to use all types of data (i.e. real-time, pre-recorded, or randomized). In one embodiment of the invention, the training tool may use real-time market data. Such an embodiment would allow a day-trader to use the latest market conditions during his training. This may be beneficial because the real-time market data will accurately reflect current market conditions. Therefore, when the time comes for the day trader to execute real trades, the day trader is up-to-date on the latest market conditions. In another embodiment, the training tool may use previously recorded data. This would allow the day-trader to train, even if the market is closed, such as at night, during the weekends, or on holidays. This is not to say that the training tool cannot use previously recorded data while the market is open. Rather, the option of using previously recorded data provides the day trader with the opportunity of training when the market is closed, but does not preclude the trader from using the previously recorded data while the market is open. The previously recorded data may include data recorded at any moment prior to the training session. Thus, the data may be recorded mere seconds before it is used in training, or the data may be recorded years prior to the training session. In another embodiment of the invention, the training tool may use randomized data as opposed to actual market data.

The data input 12 provides historical data from a real-time data source or from a database of stored or randomized data. A historical data value is received for each time interval. A plurality of sequential time intervals constitutes a time period. According to various embodiments of the present invention, the duration of each time interval and the corresponding time period may vary. In the trader training tool embodiment, the time period is essentially the duration of each training session. As such, it may be useful to set the duration of each time period to be equal, such as one minute intervals. Data corresponding to each interval may contain an aggregate or market ticks associated with individual trades. However, the time intervals may be non-equal and may correspond to market ticks associated with individual trades that impact the data. In the case of a day-trader, a typical day may involve execution of numerous trades throughout the trading day. As such, mental stamina is needed to be able to analyze the market on an ongoing basis throughout the day. By having a long time period the training toll may help to develop the stamina required to endure a full day of market analysis. In addition to varying the time period, the duration of the time interval may also change. Since day-traders capitalize on short-term fluctuations in the market, it may be beneficial to limit the duration of each time interval to market ticks/seconds/minutes/hours/days as desired. As the duration of each time interval is shortened, the user must make a data prediction within a shorter period of time. As such, a more experienced day-trader may find a shorter time interval to be more beneficial for training purposes. However, a novice day-trader may require more time to analyze the data before making a decision, therefore, a longer time interval may be more beneficial.

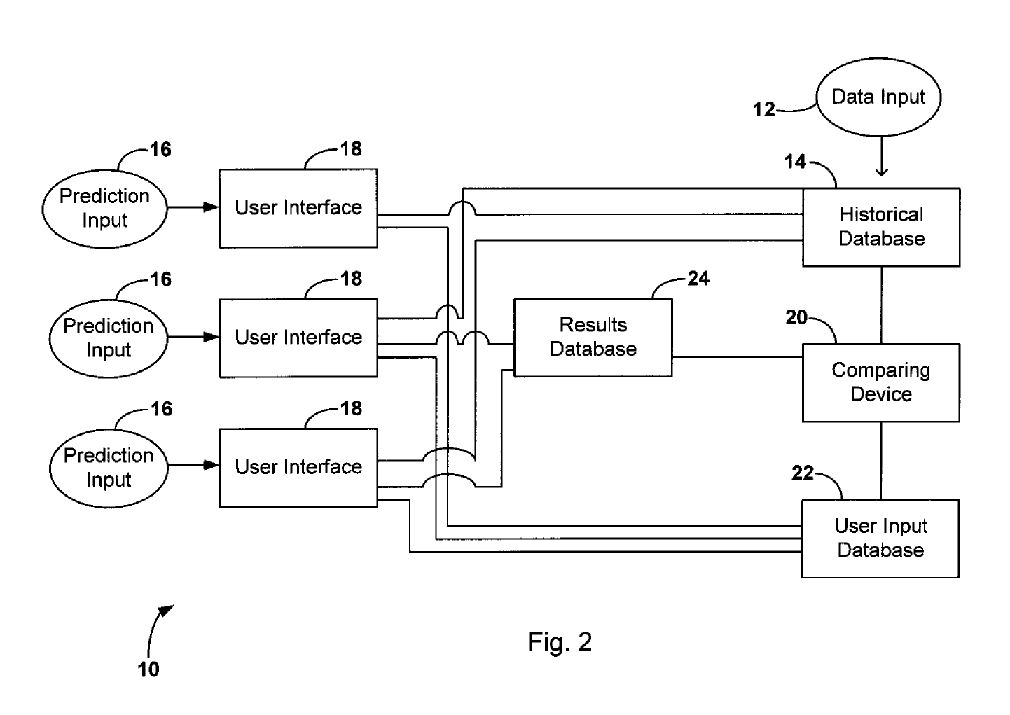

In addition to the foregoing, it is expressly contemplated that the methods of the present invention may find widespread applicability to use not only in training tool applications, but may further be implemented as a in a gaming application. According to such an embodiment a gaming module may enable a player to compare his accuracy in predicting changes in data against the accuracy of other players. The game may be particularly useful as a trade simulation gaming application. In the day-trading gaming embodiment, a player would compete as a day trader in a simulated market. The object of the game may be to accurately predict changes in financial market data. The more accurate a player is, the higher his score would be. For instance, a player may start the game with a certain amount of money and would execute trades based on his data predictions. If the player is successful, he may make money on the trade. If he is incorrect, he may lose money on the trade. In the end, the more money the player makes during the simulated trading session, the better he does. In one embodiment of the invention, the game may be played by a single user. In a one player game, the player may attempt to achieve a personal high user score. In another embodiment, the player may compete against other players. FIG. 2 is a symbolic diagram of an embodiment of the present invention allowing multiple users to perform the methods of the present invention. The other players may be actual people playing against each other, or the other players may be simulated opponents. Ultimately, the player achieving the highest score wins.

According to an aspect of the present invention, the gaming application player is provided with historical data having historical data values for each time interval. The historical data for each time interval is received via a data input 12 and displayed on a user interface 18. In the case of multiple players, each player may be provided with a user interface 18. The player analyzes the historical data in an effort to predict whether the historical data value for the subsequent time interval will increase or decrease as compared to the current time interval. A data prediction is entered from a prediction input 16. The data prediction may be generated from the user himself, or from a default source. The data prediction from each user is compared with the authentic change in the data in order to determine a user score. The user score is the number of data predictions that match the authentic changes over a given time period. When there are multiple players, the user score from each user is compared to determine a winning score. The winning score is the highest user score.

It is contemplated that the gaming application may be useful as a marketing tool. The Internet has enabled day traders to execute trades from anywhere in the world. A trader can now establish an account on a website and execute numerous trades each day. As such, a number of different websites have been created to cater to the needs of such traders. Due to the large number of websites, competition for traders is fierce. Therefore, an embodiment of the present invention may be hosted on such a website as a marketing tool to entice traders to visit the website, and ultimately execute trades through the website. As was described above, the website may allow the trader to compete alone or against other traders. The website owner may also provide incentives to play the game, including but not limited to providing the winner with a free trade, or lowering the fees associated with the trades.

According to another embodiment of the present invention, the day trading gaming application may be provided in a more traditional stand alone video game format as opposed to being hosted on a website. Specifically, the methods of the present invention may be embodied in computer executable software, thereby enabling a player to play the gaming application on a personal computer or other video game system known in the art. The game may be sold as a cartridge or disk, or may be downloadable off of the Internet.

According to a further aspect of the present invention, there is provided an article of manufacture comprising a program storage medium readable by a computer. The medium tangibly embodies one or more programs of instructions executable by a computer to perform the above described methods. As used herein, the article of manufacture may include portable data storage devices, such as floppy disks, compact disks, USB storage devices, or other portable storage devices known in the art. In addition, the article of manufacture may also include computer hardware located on a central server that can be accessible by other computers to download the program. For instance, the article of manufacture may include the memory device located in a central server, where the memory device contains the program capable of performing the above described methods.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of comparing actual and user predicted changes in data over a time period having a plurality of sequential time intervals, the method comprising the steps of:
a) receiving historical data from a data input, the historical data having historical data values with authentic changes, each authentic change being a change in historical data value between a current time interval and a subsequent time interval;
b) displaying the historical data for each time interval on a user interface;
c) receiving a data prediction for each time interval from a prediction input, the data prediction being whether the historical data value of the subsequent time interval will increase or decrease as compared to the historical data value of the current time interval;
d) comparing the data prediction for each time interval with the authentic change; and
e) generating a user score, the user score being the number of data predictions matching the authentic changes over the time period.

2. The method of claim 1 further comprising the step of storing the historical data in a historical database.

3. The method of claim 1 further comprising the step of storing the data prediction in a user input database.

4. The method of claim 1, wherein the historical data received contains real-time data.

5. The method of claim 1, wherein the historical data received contains previously recorded data.

6. The method of claim 1, wherein each time interval is equal.

7. The method of claim 1 wherein the data prediction is received from a user.

8. The method of claim 1 wherein the data prediction is received from a default source, the default source capable of sending the data prediction when the user does not enter the data prediction.

9. The method of claim 8, wherein the data prediction is an increase in the historical data value.

10. The method of claim 1, wherein the historical data relates to a financial market.

11. The method of claim 10, wherein the financial market is a stock market.

12. The method of claim 10, wherein the financial market is a commodities market.

13. A method of comparing actual and user predicted changes in data over a time period having a plurality of sequential time intervals, the method comprising the steps of:
a) receiving historical data from a data input, the historical data having historical data values with authentic changes, each authentic change being a change in historical data value between a current time interval and a subsequent time interval;
b) displaying the historical data for each time interval on a user interface, wherein each user is provided with a user interface;
c) receiving a data prediction from a prediction input for each user for each time interval, the data prediction being whether the historical data value of a subsequent time interval will increase or decrease as compared to the historical data value of a current time interval;
d) comparing the data prediction of each user for each time interval with an authentic change; and
e) generating a user score for each user, the user score being the number of data predictions matching the authentic changes over the time period.

14. The method of claim 13 further comprising the step of identifying a winning score, the winning score being the user having the highest user score.

15. The method of claim 13 further comprising the step of storing the historical data in a historical database.

16. The method of claim 13 further comprising the step of storing the data prediction in a user input database.

17. The method of claim 13, wherein the historical data received contains real-time data.

18. The method of claim 13, wherein the historical data received contains previously recorded data.

19. The method of claim 13, wherein each time interval is equal.

20. The method of claim 13 wherein the data prediction is received from each user.

21. The method of claim 13 wherein at least one data prediction is received from a default source, the default source capable of sending the data prediction when at least one of the multiple users does not enter the data prediction.

22. The method of claim 13 wherein the at least one data prediction received from a default source is an increase in historical data value.

23. The method of claim 13, wherein the historical data relates to a financial market.

24. The method of claim 23, wherein the financial market is a stock market.

25. The method of claim 23, wherein the financial market is a commodities market.

26. An article of manufacture comprising a program storage medium readable by a computer, the medium tangibly embodying one or more programs of instructions executable by a computer to perform a method of comparing actual and user predicted changes in data over a time period having a plurality of sequential time intervals, the method comprising the steps of:
a) receiving historical data from a data input, the historical data having historical data values with authentic changes, each authentic change being a change in historical data value between a current time interval and a subsequent time interval;
b) displaying the historical data for each time interval on a user interface;
c) receiving a data prediction for each time interval from a prediction input, the data prediction being whether the historical data value of the subsequent time interval will increase or decrease as compared to the historical data value of the current time interval;
d) comparing the data prediction for each time interval with the authentic change; and
e) generating a user score, the user score being the number of data predictions matching the authentic changes over the time period.
